(19) United States
(12) Patent Application Publication
(10) Pub. No.: US 2006/0083175 A1
(43) Pub. Date: Apr. 20, 2006

(54) Media client emulation tool

(76) Inventors: Dennis William Ward, Sunnyvale, CA (US); Gopalakrishna Sagar, Santa Clara, CA (US); Azizullah Syed, Santa Clara, CA (US)

Correspondence Address: DENNIS WILLIAM WARD, 164 S. PASTORIA AVE, SUNNYVALE, CA, 94086, US

(21) Appl. No.: 10/768,272

(22) Filed: Jan. 30, 2004

(51) Int. Cl. H04J 1/16

(52) U.S. Cl. 370/250; 370/352

(57) ABSTRACT

The Media Client Emulation (MC-E) Tool is a media software utility used to emulate Media Terminal Adapter (MTA) functionality for positive and negative testing of Call Management Server (CMS) devices. The MC-E communicates with the CMS devices in a variety of protocols. The MC-E can be configured to override correct protocol functionality in real time for further negative testing. MC-E can be controlled remotely for more user flexibility.

### CROSS-REFERENCE TO RELATED APPLICATIONS

None.

### FEDERALLY SPONSORED RESEARCH

None.

### SEQUENCE LISTING

None.

### FIELD OF THE INVENTION

This invention relates to Emulation Tools, specifically to Embedded Media Client devices that transmit/receive datagrams in the clear and in securely encrypted formats.

### BACKGROUND OF THE INVENTION

This invention relates generally to testing of a plurality of Telephony Server Protocols. More particularly, the invention relates to systems and methods permitting logical testing of protocol faults in a Server Unit Under Test (UUT). The emulator includes monitoring datagrams, responding to correct datagrams naturally, uncovering and detecting when the sequence of protocol datagrams diverge from the specified protocol functionality. Also overriding known good datagrams to send non-compliant datagrams for negative testing. The Call Management Server (CMS) to Media Client (MC) relationship is essentially based on a Client-Server model over a general network. As such, the MC is designed to respond to all commands given by the CMS as well as inform the CMS of any stimulus on it's physical (i.e. analog, wireless, etc.) ports. Thus, under protocol compliance testing situations for example, it is easier to test the MC device if one has a tool that can simulate a CMS server and produce call flows. However testing a CMS for protocol compliance is more difficult. The reason for this is that the MC not only has to respond as well as evaluate all of the CMS commands dynamically, but also has to be able to generate seemingly unpredictable datagram's to test the responses of the CMS. Also, for negative testing, after the CMS under test sends an acceptable datagram, the MC would have to override a legal response datagram being sent to the CMS with an unacceptable datagram within a specified time. This approach requires the MC to be intelligent. This method of testing is different from how emulation and/or protocol test tools in this space are functioning today.

### DESCRIPTION OF PRIOR ART

Emulation tool methodology to date is quite static in that one has to have an actual device “Network Handling Module” that is used as a stimulus module (i.e. cable modem, router, etc.) along with a test controller to stimulate and retrieve data from the UUT which becomes expensive if one needs to perform deeper analysis or load testing. In addition, the negative testing feature still requires an expensive apparatus as mentioned to generate relevant datagrams which may not be as detailed enough to isolate problems. A scripting entity is used to setup modules to test which can be unwieldy for very detailed analysis which is required by standards groups. (i.e. PacketCable, SCTE, etc.) In fact, this defeats the purpose of testing a device if one needs that exact device to use as a stimulus or retriever of a plurality of simultaneous communication streams between the UUT and the test controller system.

Then there is the issue of remote testing. Test System's today can be used remotely and enables thorough protocol testing however system's to date still require special hardware and capital equipment beyond the ordinary personal computer which can be very expensive for newly developed Network equipment which may not be compliant to the ever evolving network protocol specifications. When Virtual Private Network (VPN) protocol's come into play, it will be virtually impossible to test remotely since Encapsulated Security Protocol (ESP) datagrams over VPN networks are normally prohibited or require special expensive network routers to pass such datagrams through. Encrypted datagrams need to be manipulated and overridden correctly before a plurality of encryption types are employed before being sent back to the UUT.

### SUMMARY OF THE INVENTION

The Media Client Emulation (MC-E) tool is the first of it's kind to intelligently evaluate the datagram's from any CMS type of device. It responds to datagram's (i.e. PacketCable) and allows the user to insert a negative response to legal or illegal datagram's sent from the CMS. For example, if a CMS device under test sends a legal datagram with proper parameters to the MC-E to create a connection, the MC under normal conditions would respond properly. With the dynamic override utility, instead of responding affirmatively a negative response can be sent then, simulating a failed MC. This negative response will be sent every time a particular formatted datagram (i.e. CRCX) comes to the MC-E matching that profile. The results of this event should be logged in the CMS log file. The MC-E will log all events for any of it's plurality of configured endpoints. Another feature to alter the datagram is to change the verb text (i.e. header), connection id length, protocol versions, etc. This will be provided by the Special Events utility. One can also issue datagram compression types in response to the CMS with compliant or non-compliant compression types from the plurality of compression types dictated by any CMS.

The power of the MC-E emulation methodology to testing CMS compliance becomes apparent when testing several different CMS devices from different vendors. Since Signaling Specifications, for example, are still open to different interpretations CMS call flows can vary. This variance presents a challenge to the Test Engineer who needs to modify every static call flow for the MC to test basic functionality of a CMS. Take for example a simple startup sequence from a PacketCable CMS device. Some CMS devices start with sending RQNTs to all endpoints. However some devices just send an AUEP and determine the endpoints accordingly. With a static MC test tool, different scripts or program modifications will have to be made to accommodate basic variances in CMS functionality. Since the MC-E emulates a true MC, there is no need to modify any scripts or write any programs to accommodate basic CMS functionality. Modifications are required only when overrides are needed during negative testing. This can be done by just entering a text file to change a state as mentioned earlier. This scripting is NOT a program but just a note to the MC-E Tool that it needs to do something different than its true function.

Secure protocol datagram testing can occur the same way since the MC-E can generate, capture, analyze and override encrypted datagrams traversing a plurality of network connections to and from a UUT (i.e. Call Management Server). This tool can also be used for deploying Media Clients in the field for Multi-Service Operators (MSOs). MSO technicians, etc. can use this tool to make sure that the signaling between the CMS and the customer's home is correct and stable. The MC-E can also be used by the MSO Engineer in the Headend to call any Customer Premises Device (CPE) to test the endpoint's signaling and voice quality.

### BRIEF DESCRIPTION OF THE DRAWINGS

FIG. 1 is a diagram outlining the topology of a typical Media Software System interacting with a CMS (Call Management Server) and KDC (Key Distribution Center).

FIG. 2 is a conceptual view of a Media Software System interacting with a CMS and KDC.

FIG. 3 is a logical level block diagram of the MC-E's internal subsystems.

FIG. 4A-4I are examples of Graphical User Interface (GUI) Configuration Menus for the MC-E.

### DETAILED DESCRIPTION OF THE DRAWINGS

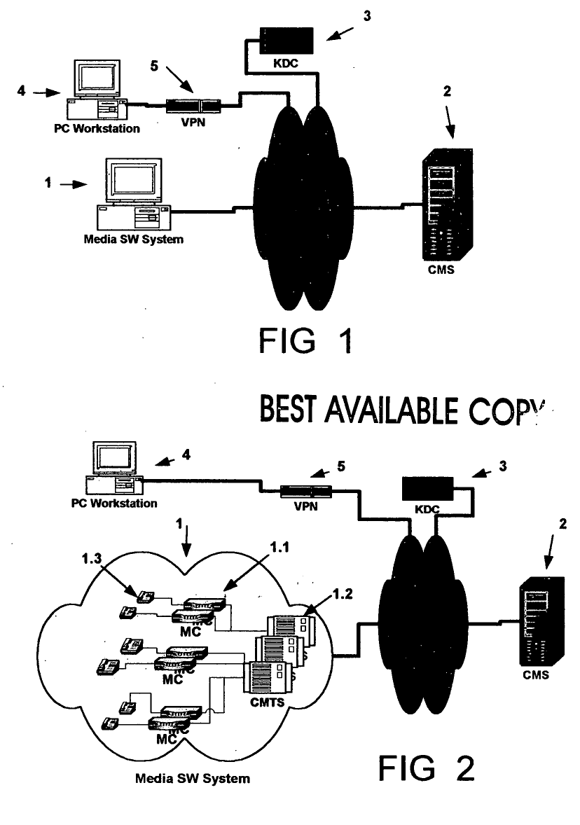

FIG. 1 is a topology outlining a typical scenario of using the Media Client utility for testing a plurality of Application Servers such as the CMS. [1] shows a Media Software System (i.e. PC) that has a CPU and Volatile Memory and a Network Interface apparatus that can talk to the internet and can process the MC-E's software. This device can receive and send TCP/UDP packets to a plurality of network devices residing on the IP Network. [2] is an example of an Application Server such as a CMS. The CMS can communicate with a plurality of devices on the IP Network as well. [3] is a typical Key Distribution Center (KDC) which is a trusted party used for Authentication of network devices such as the MC's and CMS devices. [4] is a typical Personal Computer that can be used to remotely control the MC-E residing on the Media Software System. [5] is a typical Virual Private Network (VPN) device to provide a private tunnel to the IP Network for the PC [4].

FIG. 2 element [1] is a more conceptual view of the MC-E software within the Media Software System. Notice that the MC [1.1] can be instantiated to a plurality of MC processes within the Media System. These processes create virtual links to the CMS devices and from the vantage point of the CMS device it looks like many MC devices on a network. Therefore the MC acts as a protocol entity such that these entities can handle multiple connections for different data transfer among different CMS end-system devices. These MC processes can not only create virtual connections to the CMS but also authenticate itself to the KDC [3] as a trusted entity within the IP Network's secure REALM. Communication between the IP Network devices such as the CMS, MC and the KDC in this example is via UDP packets. If secure transfer of data between the MC and the CMS is desired then the payload of the UDP packets will be encrypted and sent/received via IPSec in ESP packets. Thus, to the network, the emulated Media Client looks like individual physical Media Client devices. Traversing between the MC and the CMS are the protocol data units that will be analyzed and or overridden by the MC given the user's configuration of the MC emulated entity and protocol to be selected. [1.2] and [1.3] are also emulated entities in this particular example which are shown here and will be described in subsequent patents. The focus of this patent is on the Media Client itself. Nevertheless, [1.2] can be one of a plurality of emulated or real CMTS devices which the MC can communicate through to the CMS however they are not necessary. [1.3] are emulated phone devices which are part of the MC Emulation.

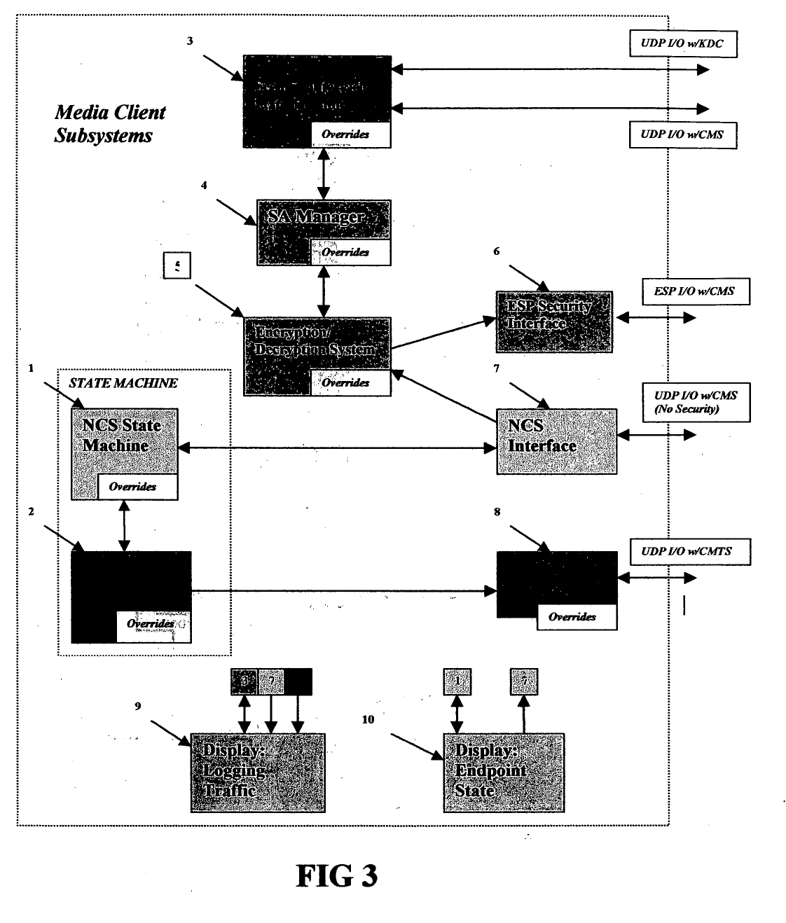

FIG. 3 The NCS state machine 1: This unit is responsible for maintaining the status of the endpoints, like on-hook/off-hook state, number properties and state of connections etc. It works in close coordination with DQoS state machine to provide a complete simulation of an embedded MTA. When an NCS message comes in, it processes the message, updates the status of endpoints, and returns an appropriate reply. It also responds to user input (for instance, by sending an NTFY O:hd packet when the user clicks the ‘lift handset’ button). Overrides: You can set overrides at this point to return some non-default and/or malformed replies for the incoming NCS packets. and delaying messages.

DQoS state machine 2: This unit maintains the status of DQoS gates that have been assigned to a given connection through MDCX or CRCX commands. This subsystem is also responsible for sending the appropriate Dynamic Service (DSx) messages, and interpreting the incoming messages.

Security interface/state machine 3: This unit is responsible for setting up security interfaces, sending & receiving Kerberos messages to/from KDC & CMS. It continuously keeps track of available Security Associations (SAs) and tickets, and initiates a negotiation of a new SA or ticket when necessary. It also responds to incoming Wakeup and Rekey messages from CMS, in order to initiate a new SA negotiation. The SAs that are established are handed over to SA Manager unit [4]. Overrides: A series of overrides are available in this module, to facilitate a thorough positive and negative testing of the CMS′ security interface. They include (but not limited to) corrupting the checksums, using wrong tickets

SA Manager 4: This unit maintains the SAs that are established by the Security Interface. These SAs are in turn, requested and used by the Encryption/Decryption system [5]. Overrides: You can force the unit to continue using an expired SA instead of a concurrent one, in order to check the ability of CMSs to detect SA expirations.

Encryption/Decryption System 5: This unit stands between the ESP security interface [6] and NCS interface [7], encrypting the outgoing messages and decrypting the incoming messages. It interfaces with SA Manager [4] to select and use the appropriate SA for each message.

ESP Security Interface 6: This unit opens and maintains ESP connections (sockets), filtering incoming messages before handing them to encryption/decryption system [5]. It also sends out the outgoing ESP messages prepared by [5].

NCS Interface 7: This unit is responsible for isolating the security system details from the NCS state machine. When NCS state machine sends out a message to the CMS, the NCS interface sends it out to a UDP interface or encryption/decryption system, based on whether secure NCS is requested or not. Same way, the incoming messages are handed out to NCS state machine in virtually the same structure irrespective of whether the packet came in encrypted or plain text.

Dynamic Quality of Service (DQOS) interface 8: This unit is the front-end for DQoS state machine. It is expected that this unit will facilitate easier implementation of Secure DQoS messaging when required.

Display & logging of traffic 9: This unit captures and logs (on screen as well as into a log file) all the incoming and outgoing NCS/Security/DQoS traffic. You can set the logging levels to capture as much or as little information as you need.

Capturing to a log file is optional.

Display of endpoint state 10: This unit has two purposes: First, it displays the current state of the endpoint (e.g. whether it is on-hook or off-hook, what signals are applied to endpoint, the digits that are dialed, caller IDs coming in, etc.); Second, it displays a dial pad, and buttons so that users may go off-hook, dial digits, flash hook and so on, in a logical and convenient way.

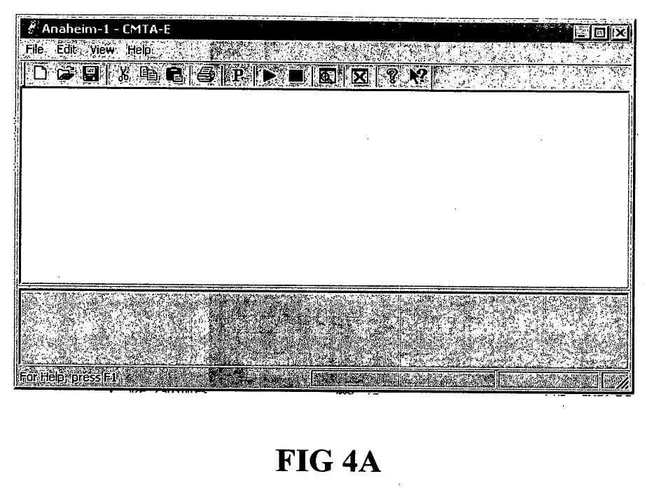

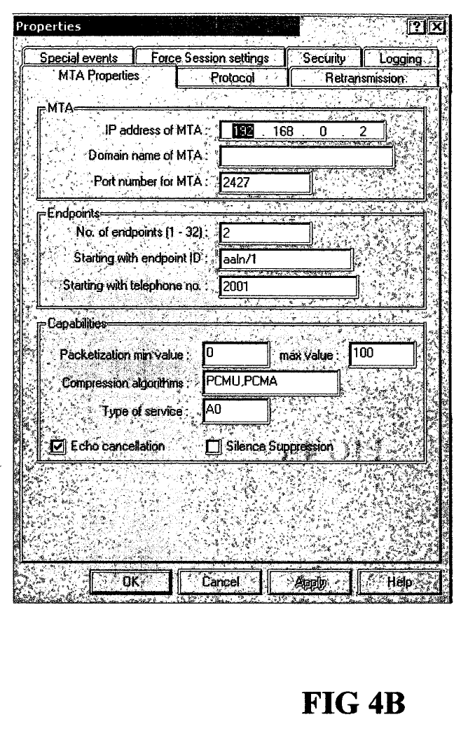

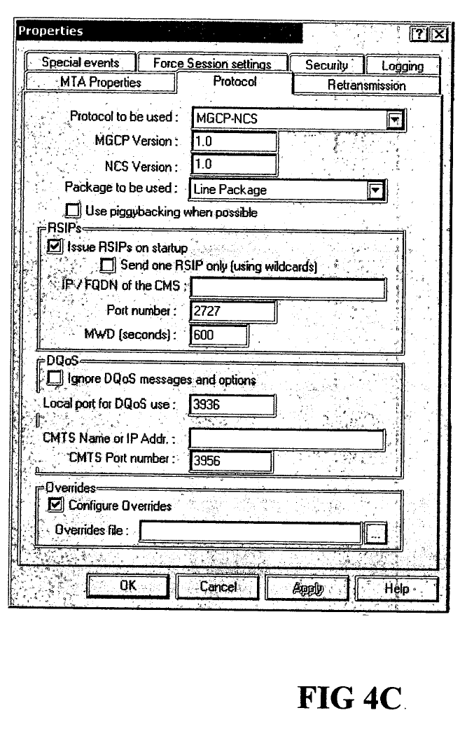

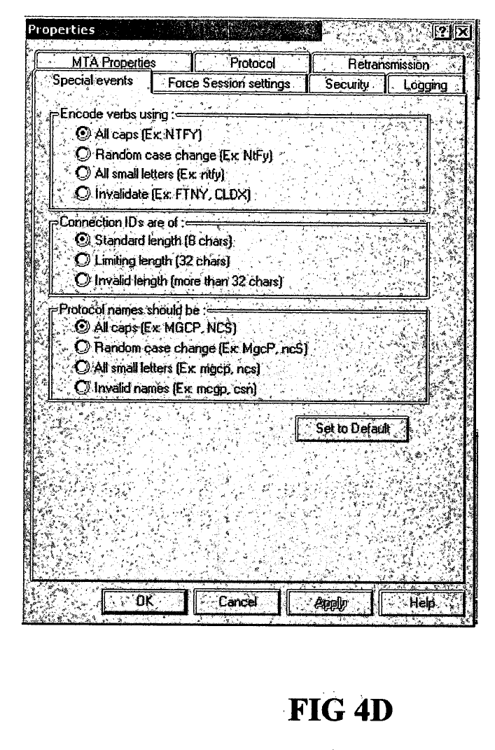

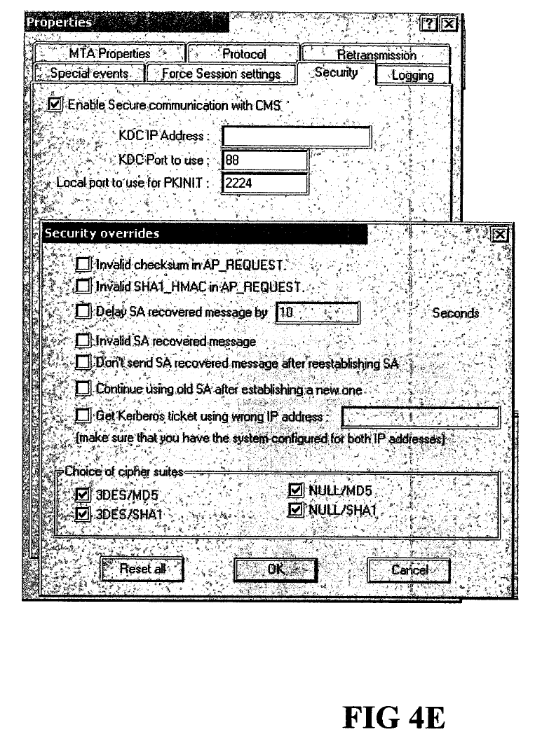

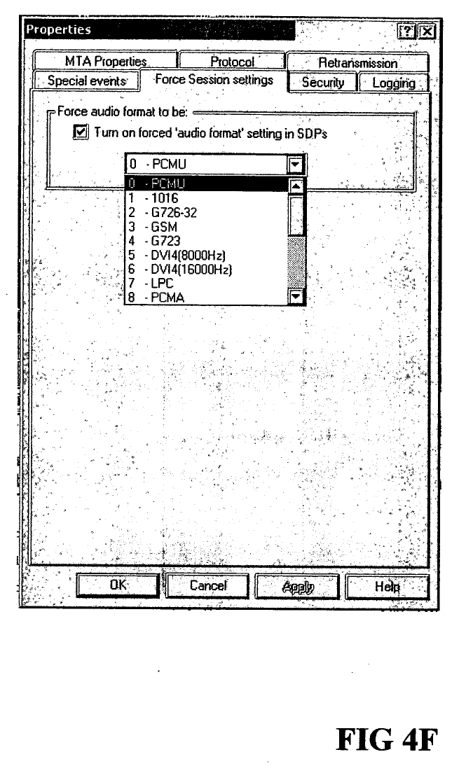

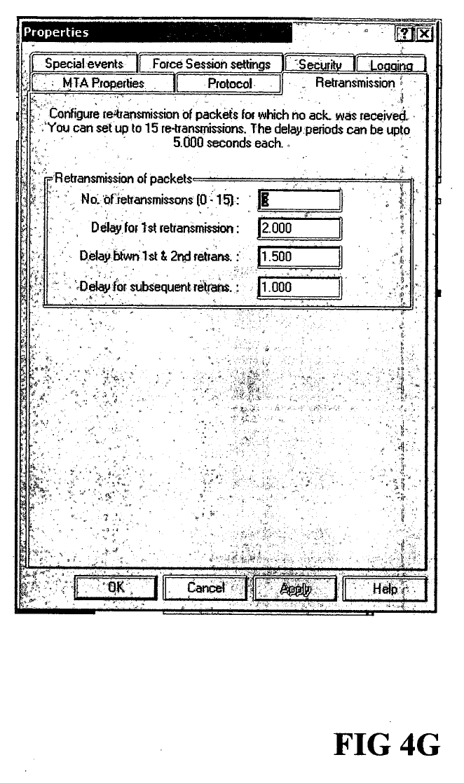

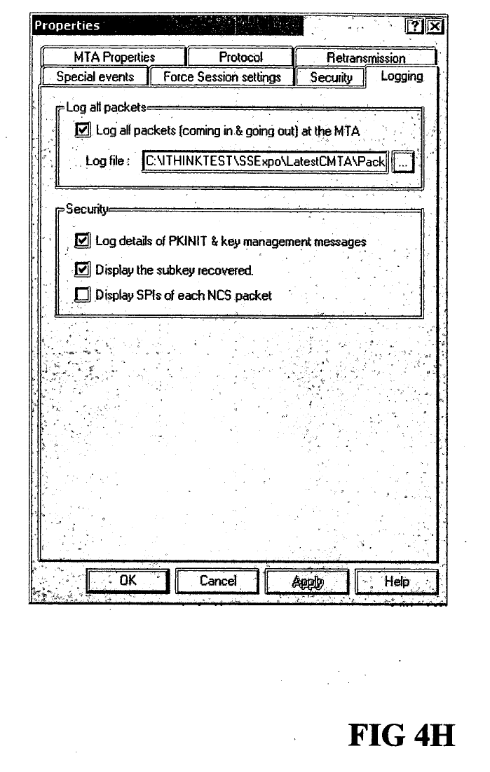

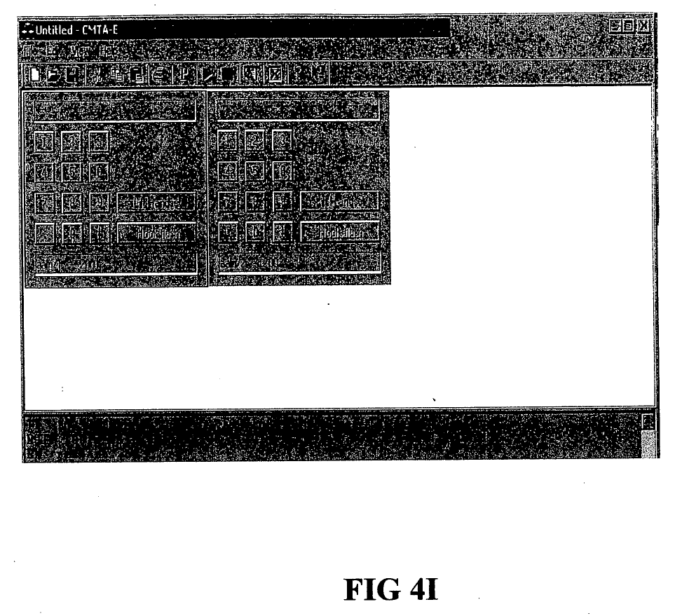

FIG. 4A MC-E Setup Application: This GUI is the main user interface for configuration of the application. The user will select the Properties “P” indicator to see the following GUI configuration menu selections outlined in FIGS. 4B-4H.

FIG. 4B MTA Properties: The GUI menu to set the basic MTA addresses and capabilities to communicate on the network. This GUI provides the user with the selection of Endpoints, endpoint ID and starting telephone numbers.

FIG. 4C Protocol Selections: This GUI provides the user the facility to set a plurality of protocol selections for communicating with the CMS system under test, whether Reset In Progress (RSIP) attributes need to be sent, port settings, Maximum Wait Delay (MWD) times before the MTA becomes active, Dynamic Quality of Service (DQoS) and CMTS address to set and which type of Override functions files to use. This GUI essentially controls the state machine subsystems outlined in FIG. 3 items 1, 2, 7 and 8. The override file feature within this GUI are parameters into the override features outlined in FIG. 3.

DQoS Overrides: An override (shown in FIG. 4C) allows you to ignore DQoS messages and options. When this override is set, the dq-gi and dq-rr options in the LCO are ignored and calls will be setup without reserving or comitting the gate resources.

MC-E Override Utility: The override utility within this GUI essentially captures the path to a file that houses parameters into the override features outlined in FIG. 3. This file is essentially a scripted datagram that will be sent in real-time in response to a datagram that is sent by the Call Management Server under test. The override utility is used to alter responses to the CMS Device Under Test as they come into the MC-E. This utility is used to simulate a failure during any phase of the call flow between the MTA and CMS. For example, if the MC-E receives a RQNT from the CMS UUT with a “L/hu” in requested events, instead of sending an ‘ACK 200’ send a NACK with a value “501” and message string ‘endpoint is not ready’ via a text file. The procedure is as follows:
1. Open a text file and draft a profile of the expected datagram from the CMS then place an equal sign (=).
2. On the same line, after the equal sign, draft a profile of the datagram that is to be sent to the CMS.
3. There should be only one cms-receive/mta-send pair per line.
4. There can be multiple cms-receive/mta-send pairs in the text file to scan for.
   Override Syntax:

The overrides are specified as a series of command-response specifications.

Each line would contain a command part and a response part separated by a ‘=’.

Example:

In a file specified with a suffix of .OVS—“FILENAME.OVS”, an override line can look like this:

RQNT R<L/hu> S<l/dl>=501 % T endpoint not ready \n.\nRSIP % Y % @ % V\nRM: graceful\nRD: 300

This line means: If the MC-E entity sees the RQNT “L/hu” come from the CMS, send back to the CMS a 501 response piggybacked with a RSIP.

Command Specification:

The command specification consists of a Verb and a series of parameters.

The verb may be one of: RQNT,CRCX,MDCX,DLCX,AUEP,AUCX or may be anything else for that matter.

The allowed “command<>” codes for the command specification are as follows:

M—connection mode

T—detect events

D—digit map

L—local connection options

N—notified entity

Q—quarantine handling

R—requested events

F—requested info

K—response acks

S—signal request.

The checking for a specific parameter can be skipped by simply eliminating that parameter from the list. For example, if a command specification says: ‘RQNT’, without any parameters, ALL request notifications will be overridden by the specified command.

The checking for overrides is done in descending order. Thus, something in line 2 takes priority over a case in line 6. Hence, it is recommended that if you want to invoke a particular case first, put that case in preceding lines. Then add in subsequent cases.

Note the override mechanism is kept simple and easy so it will not distinguish between basic events. For example, it does not recognize that a requested event of <hd> is the same as <L/hd>. Therefore you may put in two overrides to cover both the cases. The checking is case insensitive, however, so a <L/hd> is the same as <l/HD>.

Response Specification:

A response packet can be scripted with legal contents as well as carry over variable information.

A ‘\n’ in the response line denotes a Line Feed—LF (or a CRLF combination) in the packet.

The variable components of the packet are specified using a ‘%’ code. Note that ‘%’ ALWAYS denotes a coded element. Thus, if you need the actual ‘%’ character in the response packet, you need to specify it as ‘%%‘. The following are the allowed codes:

% T—Transaction id (of the received—packet)

% Y—New transaction id (A new ID generated internally—guaranteed to be unique for at least next 1000 packets for that endpoint.)

% V—Version string (for ex: MGCP 1.0 NCS 1.0)

% C—Call id (may be a zero-length string if no call id is available)

% I—Connection id (may be a zero-length string)

% X—Last received request id (may be “0”, if none available)

% @—Fully qualified name of the endpoint (for ex: aaln/1@any.domain.net or aaln/1@[192.168.0.233])

%%—insert a ‘%’ character at this location.

Override Example:

We can add an additional unknown extension to the response for the DLCX from MTA using an override function as follows:

RX: 16:01:36.395 Received from: 10.1.254.36:2727:

DLCX 1600 aaln/2@cmta7.pclab.com MGCP 1.0 NCS 1.0

l: 10020020

C: 66

TX: 16:01:36.395 Sent to: 10.1.254.36:2727:

250 1600 OK

P: PS=0, OS=0, PR=0, OR=0, PL=0, JI=0, LA=0

PC/RPS=0, PC/ROS=0, PC/RPL=0, PC/RJI=0

X-abcd

Above underlined extension “X-abcd” is being added due to the override function

The actual override function looks as below:

DLCX=250% T OK \nP: PS=0, OS=0, PR=0, OR=0, PL=0, JI=0, LA=0\nPC/RPS=0,PC/ROS=0,PC/RPL=0,PC/RJI=0 \n X-abcd

Which is written in notepad and added to the MTA configuration at appropriate “Override” location under “Protocols” tab in MTA properties.

Additional Notes:

Overridden packets will not be processed further by the emulator. The Override function simulates a MTA failing at a given point with a response to the CMS. Similarly, the outgoing packet—as specified by the override—will not be parsed by the emulator. This means that information will not be updated in the internal state. For example, if the emulator detects an override event it would process it first before servicing an off hook. Thus, the internal state machine wouldn't update it's state. So the state of the endpoint will remain on-hook.

FIG. 4D Special Events: This GUI provides the user with selections for different test scenarios such as protocol verb anomalies, connection ID issues, etc.

NCS Overrides

You can specify a file containing overridden responses to various incoming NCS messages. The message can be as detailed as you want. For example, you can specify an overriding response to CRCX (where all incoming CRCX messages will get the overriding response) or you can specify an overriding response to CRCX S<rt> (where only the incoming CRCX messages with a signal request containing ‘rt’ will get the overriding response).

New feature being added: It is possible to optionally process an overridden packet when you choose this option, the response generated by the override function will be parsed by the NCS emulator and the internal status updated, to the extent possible.

Special Encoding

This set of overrides allow the user to modify the NCS behavior. You can have the verb or protocol name encoded with all/none/random capitalization, or have invalid verbs/protocol names. You can select the length of connection ID to be 1/8/32/invalid number of characters, change the requirement for ‘response ACKs’ and select the RSIP format. FIG. 4D.

3. Session Settings

Like ‘Special encoding’ these overrides the change the NCS behavior, but specific to session establishment. One override allows you to force the MTA to select a SPECIFIC codec irrespective of what codecs were specified by the CMS in CRCX/MDCX. Another override allows multiple selection of codecs. A third override allows adding custom data at the end of a prepared SDP. FIG. 4F.

FIG. 4E Security Parameters/Overrides: These GUI interfaces enable secure communications with the CMS device(s). The attributes such as the KDC parameters, REALM entity variables, etc. For test case scenarios the Security Override features GUI would be used. The selections sighted here provide selections for a plurality of tests. These selections are parameters to the MC Security Subsystems in FIG. 3 items 3, 4, 5 and 6.

Security Interface Overrides

Security overrides take three forms.

One is to add/remove/modify the internal values of an outgoing KDC or KKM message. The result will be an invalid KKM message or (in case of KDC message), a ticket from KDC that should be unacceptable to the CMS. This allows one to check the response of CMS for these invalid messages. The following overrides follow this test methodology:
a. Invalid checksum in session ticket
b. Invalid checksum in AP_REQUEST
c. Invalid SHA1-HMAC in AP_REQUEST
d. Add USE_SESSION_KEY option in AP_REQUEST
e. Add unsupported option (0x10) in AP_REQUEST
f. Fill authorization-data field in AP_REQUEST
g. Use unsupported ciphersuite (0x23/SHA1) in AP_REQUEST
h. Fill checksum field in Authenticator
i. Invalid protocol version in AP_REQUEST
j. Invalid SA Recovered message
k. SA recovered message with invalid SHA1-HMAC
l. Respond to wakeup with unsolicited AP_REQUEST

Second form of override uses wrong IP addresses and/or port numbers to communicate with KDC and/or KKM, thereby testing the CMS's ability to spot the renegade behavior. Example of this form of override:
a. Get kerberos ticket using wrong IP address
b. Use wrong IP address for AP_REQUEST after reestablishment

Third form of override involves in delaying or stopping responses to certain situations in security establishment. Examples:
a. Delay SA recovered message by ______ seconds
b. Don't send SA recovered message after reestablishment
c. Do not respond to wakeup
d. Response to wakeup delayed by ______ seconds
   SA Manager Overrides

There is one override in SA Manager unit that allows use of an old SA even after the establishment of new SAs and/or the old SA expires. This allows the testing of the CMS to make sure that it allows the usage of an SA as long as it is valid AND that it doesn't allow the usage of that SA after it expires.

Encryption/Decryption System Overrides

An override in Encryption/Decryption system allows the user to send out NCS packets without encryption to see if CMS responds to it. When an MTA is configured (in CMS) as ‘secure’, the CMS is not supposed to respond to plaintext NCS messages from that MTA.

FIG. 4F Force Session Settings: This GUI provides CODEC variable types to insert within Session Description Protocol (SDP) packet to send to the CMS. These GUI parameters are inputs into the subsystems outlined in FIG. 3 items 1 and 7.

FIG. 4G Retransmission Settings: This GUI controls the retry packets to the CMS.

FIG. 4H Logging Selections: This GUI provides the user with the ability to log various levels of data and also a path to place the log file within the system.

FIG. 4I MC-E Viewer: This GUI interface is the same as the initial setup interface. However this screen shot shows the MC-E endpoint entities and the real time log file. The view of this interface corresponds with the display subsystems outlined in FIG. 3 items 9 and 10.

What is claimed is:

1. A Media software system that emulates communication devices to test Voice over Network (VoN) Application Server devices.

2. A system as described in claim 1, with the ability to override responses in real-time to stimulate expected responses.

3. A system as described in claim 1, with the ability to override responses in real-time to alter expected responses.

4. A system as described in claim 1, with the ability to override responses in real-time due to an utility that takes a scripted text file and uses the contents to analyze incoming datagrams from an Application Server. If the expected values within the scripted text file is identified, the utility will send the scripted text file's contents in place of the expected natural datagram from the MC subsystems flow.

5. A system as described in claim 1, with the ability to instantiate multiple entities of itself with the exact form and function to appear to the Application Server as many MTAs.

6. Security: A Media software system that encodes and decodes Key Management Destribution Centered (KDC) datagrams.

7. A system as described in claim s6, that encodes and decodes secure KDC datagrams for authentication and encryption services.

8. A system as described in claim s6, that sends Kerberos datagrams using PKINIT to KDC systems for authentication to obtain Ticket Granting Tickets (TGTs) and session keys.

9. A system as described in claim s6, that receives secure TGTs to decode until the subkey is obtained for creating Security Parameters for communication to Management Servers.

10. A system as described in claim s6, that transmits and receives encrypted datagrams to created a pair of Security Associations between Management Servers Under Test via IPSec.

11. A system as described in claim s6, to override known good secure datagrams with corrupt secure datagrams.

12. A system as decribed in claim s6, to override known good AS-Requests to the KDC with corrupt parameters to evaluate negative responses.

13. A system as described in claim s6, to override know good AP-Requests to the Management Server Under Test to evaluate negative responses.

14. A system as described in claim s6, to reply normally or abnormally to WakeUp messages from the Management Server.

15. A system as described in claim s6, to reply normally or abnormally to ReKey messages from the Management Server.
